(19) United States
(12) Patent Application Publication
(10) Pub. No.: US 2025/0129634 A1
(43) Pub. Date: Apr. 24, 2025

(54) Remote opening animal crate apparatus and method

(71) Applicant: Guardian K9 Lock Solutions, LLC, Tarpon Springs, FL (US)

(72) Inventors: Harry B. Lee, JR., Tarpon Springs, FL (US); Tim Baird, Piedmont, AL (US)

(21) Appl. No.: 18/812,246

(22) Filed: Aug. 22, 2024

Related U.S. Application Data
(60) Provisional application No. 63/533,963, filed on Aug. 22, 2023.

(51) Int. Cl. E05B 47/00; A01K 1/03

(52) U.S. Cl. CPC E05B 47/0004; A01K 1/033; E05B 2047/0016; E05B 2047/0095

(57) ABSTRACT

A remote opening animal crate apparatus and method consists of an animal crate with a door where the door is movably connected with the animal crate such that the door is movable from a closed position to an open position. A locking device, where the locking device includes a lock pin, where the locking device is configured to operate between a locked position and an unlocked position such that when the locking device is in the locked position, the lock pin holds the door in the closed position and a remote operating device where the remote operating device and the locking device are connected such that the remote operating device when activated operates to cause the lock pin to move from the locked position to the unlocked position.

### CROSS-REFERENCE TO RELATED APPLICATIONS

This application claims the benefit of U.S. Provisional Application No. 63/533,963, filed Aug. 22, 2023, which is hereby incorporated by reference.

### FIELD OF THE DISCLOSURE

The present invention pertains to a remote opening animal crate apparatus and method consisting of an animal crate with a door where the door is movably connected with the animal crate such that the door is movable from a closed position to an open position. A locking device, where the locking device includes a lock pin, where the locking device is configured to operate between a locked position and an unlocked position such that when the locking device is in the locked position, the lock pin holds the door in the closed position and a remote operating device where the remote operating device and the locking device are connected such that the remote operating device when activated operates to cause the lock pin to move from the locked position to the unlocked position.

### BACKGROUND OF THE INVENTION

A problem exists in the field of animal transporting in that it is necessary to ensure that the animal is secure in the transportation device, an animal crate for example, while at the same time it is important to be able to release an animal from the animal crate when needed.

Typically, there is no urgency in releasing an animal yet, at times, there is a great deal of urgency as when the animal is a danger to itself or others or is itself in danger while restrained within the animal crate. This raises the problem of how to approach the animal crate close enough to disengage the prior art locking mechanism and also how to unlock the animal crate expeditiously when time is of the essence and the caretaker is still a long way from the animal crate.

None of the prior art of which Applicant is aware, combination locks, key locks, rope and wire, addresses these problems, none are the same or similar structurally and none are as easy and economical to install and operate as Applicant's improved remote opening animal crate device.

Thus, there is a need in the art for a process that addresses the aforementioned problems in a manner that is robust and flexible so as to accommodate a full spectrum of animal enclosure shapes and dimensions.

It therefore is an object of this invention to provide an improved remote opening animal crate apparatus and method that is easy to use and economical to install and operate.

### SUMMARY

Accordingly, a remote opening animal crate apparatus and method according to a preferred embodiment consists of an animal crate with a door where the door is movably connected with the animal crate such that the door is movable from a closed position to an open position. A locking device, where the locking device includes a lock pin, where the locking device is configured to operate between a locked position and an unlocked position such that when the locking device is in the locked position, the lock pin holds the door in the closed position and a remote operating device where the remote operating device and the locking device are connected such that the remote operating device when activated operates to cause the lock pin to move from the locked position to the unlocked position.

In one aspect, the remote operating device and the locking device are wirelessly connected.

In another aspect, the locking device is push-pull solenoid and in another aspect, the push-pull solenoid is a twelve volt or twenty-four volt push pull solenoid.

In one aspect, the remote operating device is selected from a group consisting of: a computer, a smart phone, an IPad and a RF key fob.

In a further aspect, the animal crate is a dog crate.

According to another embodiment, a remote opening animal crate apparatus consists of an animal crate with a door where the door is movably connected with the animal crate such that the door is movable from a closed position to an open position. A locking device where the locking device includes a lock pin where the locking device is configured to operate between a locked position and an unlocked position such that when the locking device is in the locked position, the lock pin holds the door in the closed position and where the locking device is push-pull solenoid and a remote operating device where the remote operating device and the locking device are connected such that the remote operating device when activated operates to cause the lock pin to move from the locked position to the unlocked position and where the remote operating device is selected from a group consisting of: a computer, a smart phone, an IPad and a RF key fob.

In one aspect, the remote operating device and the locking device are wirelessly connected.

In one aspect, the push-pull solenoid is a twelve volt or twenty-four volt push pull solenoid.

In another aspect, the animal crate is a dog crate.

According to another embodiment, a remote opening animal crate method consists of:
a. providing an animal crate with a door where the door is movably connected with the animal crate such that the door is movable from a closed position to an open position; a locking device where the locking device includes a lock pin where the locking device is configured to operate between a locked position and an unlocked position such that when the locking device is in the locked position, the lock pin holds the door in the closed position and a remote operating device where the remote operating device and the locking device are connected such that the remote operating device when activated operates to cause the lock pin to move from either the locked position or to the unlocked position; and
b. operating the remote operating device.

In one aspect, the remote operating device and the locking device are wirelessly connected.

In another aspect, the locking device is push-pull solenoid and in another aspect, the push-pull solenoid is a twelve volt or twenty-four volt push pull solenoid.

In one aspect, the remote operating device is selected from a group consisting of: a computer, a smart phone, an IPad and a RF key fob.

In a further aspect, the animal crate is a dog crate.

### BRIEF DESCRIPTION OF THE DRAWINGS

Other objects, features and advantages of the present invention will become more fully apparent from the following detailed description of the preferred embodiment, the appended claims and the accompanying drawings in which:

FIG. 1 is a perspective view of the remote opening animal crate of the present invention with the door in the closed and locked position; and

FIG. 2 is a perspective view of the invention of FIG. 1 after operation of the remote operating device showing the door in the unlocked and open position.

### DETAILED DESCRIPTION OF EMBODIMENTS

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. In alternative embodiments, one or more process steps may be implemented by a user assisted process and/or manually. Other alterations or modifications of the above processes are also contemplated.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

It should also be noted that a plurality of hardware and software based devices, as well as a plurality of different structural components, may be utilized to implement the invention. Furthermore, and as described in subsequent paragraphs, the specific configurations illustrated in the drawings are intended to exemplify embodiments of the invention and that other alternative configurations are possible.

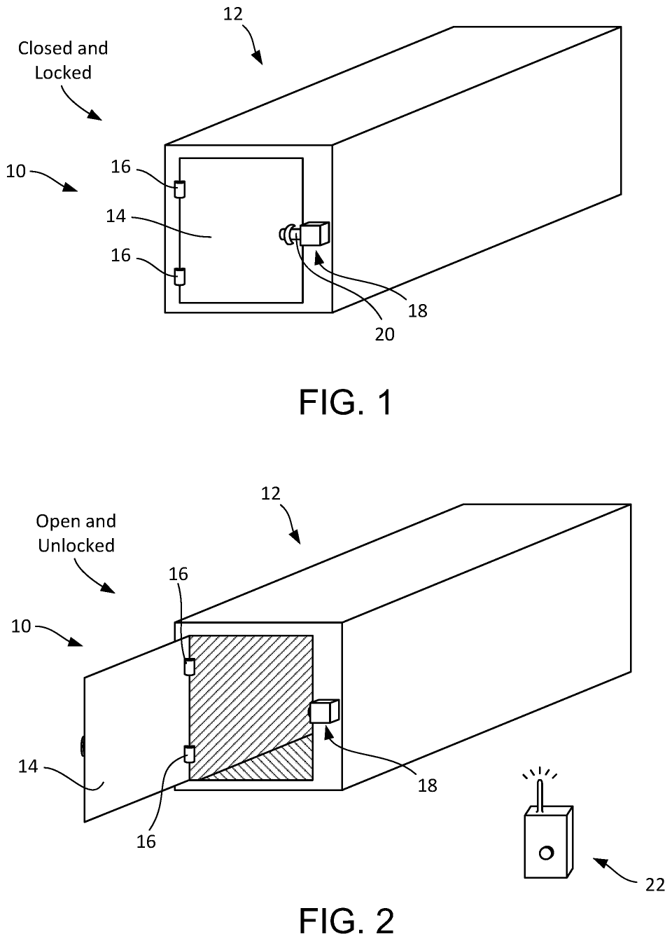

One embodiment of the present invention is illustrated by way of example in FIGS. 1-2. Referring to FIG. 1, remote opening animal crate apparatus and method 10, according to a preferred embodiment, consists of an animal crate 12 with a door 14 where the door 14 is movably connected, as with hinges 16 or the like, with the animal crate 12 such that the door 14 is movable from a closed position, as shown in FIG. 1, to an open position, as shown in FIG. 2.

A locking device 18, includes a lock pin 20, where the locking device 18 is configured to operate between a locked position, FIG. 1, and an unlocked position, FIG. 2, such that when the locking device 18 is in the locked position, the lock pin 20 holds the door 14 in the closed position. Any locking device 18 now known or hereafter developed is included within the scope of the invention and locking pin 20 is representative only of a means for locking the door 14 and is not to be limited thereto.

Remote operating device 22 is connected with locking device 18 such that the remote operating device 22 when activated operates to cause the lock pin 20, for example only and not by limitation, to move from the locked position to the unlocked position.

In one aspect, the remote operating device 22 and the locking device 18 are wirelessly connected.

In another aspect, the locking device 18 is push-pull solenoid and in another aspect, the push-pull solenoid is a twelve volt or twenty-four volt push pull solenoid.

In one aspect, the remote operating device 22 is selected from a group consisting of: a computer, a smart phone, an IPad and a RF key fob.

In a further aspect, the animal crate 12 is a dog crate.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as defined by the following claims.

We claim:

1. A remote opening animal crate apparatus comprising:
an animal crate with a door wherein the door is movably connected with the animal crate such that the door is movable from a closed position to an open position;
a locking device wherein the locking device includes a lock pin wherein the locking device is configured to operate between a locked position and an unlocked position such that when said locking device is in the locked position, the lock pin holds the door in said closed position; and
a remote operating device wherein the remote operating device and said locking device are connected such that said remote operating device when activated operates to cause the lock pin to move from the locked position to the unlocked position.

2. The apparatus of claim 1, wherein the remote operating device and the locking device are wirelessly connected.

3. The apparatus of claim 1, wherein the locking device is push-pull solenoid.

4. The apparatus of claim 3, wherein the push-pull solenoid is a twelve volt or twenty-four volt push pull solenoid.

5. The apparatus of claim 1, wherein the remote operating device is selected from a group consisting of: a computer, a smart phone, an IPad and a RF key fob.

6. The apparatus of claim 1, wherein the animal crate is a dog crate.

7. A remote opening animal crate apparatus comprising:
an animal crate with a door wherein the door is movably connected with the animal crate such that the door is movable from a closed position to an open position;
a locking device wherein the locking device includes a lock pin wherein the locking device is configured to operate between a locked position and an unlocked position such that when said locking device is in the locked position, the lock pin holds the door in said closed position wherein the locking device is push-pull solenoid; and
a remote operating device wherein the remote operating device and said locking device are connected such that said remote operating device when activated operates to cause the lock pin to move from the locked position to the unlocked position and wherein the remote operating device is selected from a group consisting of: a computer, a smart phone, an IPad and a RF key fob.

8. The apparatus of claim 7, wherein the remote operating device and the locking device are wirelessly connected.

9. The apparatus of claim 7, wherein the push-pull solenoid is a twelve volt or twenty-four volt push pull solenoid.

10. The apparatus of claim 7, wherein the animal crate is a dog crate.

11. A remote opening animal crate method consisting of:
providing an animal crate with a door wherein the door is movably connected with the animal crate such that the door is movable from a closed position to an open position; a locking device wherein the locking device includes a lock pin wherein the locking device is configured to operate between a locked position and an unlocked position such that when said locking device is in the locked position, the lock pin holds the door in said closed position and a remote operating device wherein the remote operating device and said locking device are connected such that said remote operating device when activated operates to cause the lock pin to move from either the locked position or to the unlocked position; and
operating the remote operating device.

12. The method of claim 11, wherein the remote operating device and the locking device are wirelessly connected.

13. The method of claim 11, wherein the locking device is push-pull solenoid.

14. The method of claim 13, wherein the push-pull solenoid is a twelve volt or twenty-four volt push pull solenoid.

15. The method of claim 11, wherein the remote operating device is selected from a group consisting of: a computer, a smart phone, an IPad and a RF key fob.

16. The method of claim 11, wherein the animal crate is a dog crate.
